(19) United States
(12) Patent Application Publication
(10) Pub. No.: US 2006/0247812 A1
(43) Pub. Date: Nov. 2, 2006

(54) Rearview mirror having a music player module

(75) Inventor: Shin-Chung Chen, Taoyuan (TW)

Correspondence Address: BACON & THOMAS, PLLC, 625 SLATERS LANE, FOURTH FLOOR, ALEXANDRIA, VA, 22314, US

(73) Assignee: Tung Thih Enterprise Co. , Ltd., Taoyuan (TW)

(21) Appl. No.: 11/142,267

(22) Filed: Jun. 2, 2005

(30) Foreign Application Priority Data
Apr. 27, 2005 (TW) 094206621

(51) Int. Cl. G06F 17/00

(52) U.S. Cl. 700/94

(57) ABSTRACT

A rearview mirror used inside a car is disclosed to include a casing, which defines an accommodating chamber, a data storage device, which has stored therein MP3 music files, and a music player module, which is received in the accommodating chamber of the casing, having a digital music decoder electrically connectable to the data storage device for fetching storage MP3 music files and decoding fetched MP3 music files, and a Frequency Modulation (FM) transmitter electrically connected to the digital music decoder for wirelessly send out the decoded MP3 music files.

### BACKGROUND OF THE INVENTION

1. Field of the Invention

The present invention relates to a rearview mirror for motor vehicle and more particularly, to a rearview mirror, which has a music player module received therein.

2. Description of Related Art

For playing a digital music file (such as MP3) in a car, a music player capable of playing MP3 music files must be installed in the car. It is expensive to change a car's music player. When changing the music player of a car, the stereo system and or the internal structure of the car may have to be changed too. It takes much time and cost to complete such a change. Further, a conventional digital music player cannot play different types of digital music files. Further, due to limited capacity of storage means, a conventional digital music player does not allow the user to expand storage digital music files for playing.

Further, currently commercially available digital music players are not specifically designed for use in a car. They cannot be directly combined to parts inside a car. When a digital music player is used in a car, it occupies much inside space of the car.

### SUMMARY OF THE INVENTION

The present invention provides a vehicle rearview mirror, which comprises a casing, a data storage device, and a music player module. The casing has an accommodating chamber. The data storage device has stored therein at least one digital music file. The music player module is received in the accommodating chamber of the casing, comprising a digital music decoder electrically connectable to the data storage device for fetching the at least one digital music file from the data storage device and decoding each fetched digital music file, and a Frequency Modulation (FM) transmitter electrically connected to the digital music decoder and adapted to wirelessly send out the at least one digital music file decoded by the digital music decoder.

Therefore, the music player module in the rearview mirror can decode digital music files and wirelessly send out the decoded digital music files to the FM radio of the car for output through the speaker inside the car. Because the music player module is received inside the rearview mirror, the invention fully utilizes the limited inside space of the car, keeping the sense of beauty of the inside space of the car intact.

Each digital music file stored in the data storage device can be a MP3 music file, WMA music file, or MIDI music file.

The data storage device can be a portable data storage device of Mass Storage Class (flash memory), a memory built in the music player module, or the combination of both the flash memory and the built-in memory.

The rearview mirror further comprises a control circuit board mounted inside the casing. The control circuit board comprises a second connecter. The music player module comprises a second connecter electrically connected to the first connecter of the control circuit board.

### BRIEF DESCRIPTION OF THE DRAWINGS

FIG. 1 is a schematic drawing showing a status of use of the present invention in a car.

FIG. 2 is an exploded view of the preferred embodiment of the present invention.

FIG. 3 is a functional block diagram of the preferred embodiment of the present invention.

### DETAILED DESCRIPTION OF THE PREFERRED EMBODIMENT

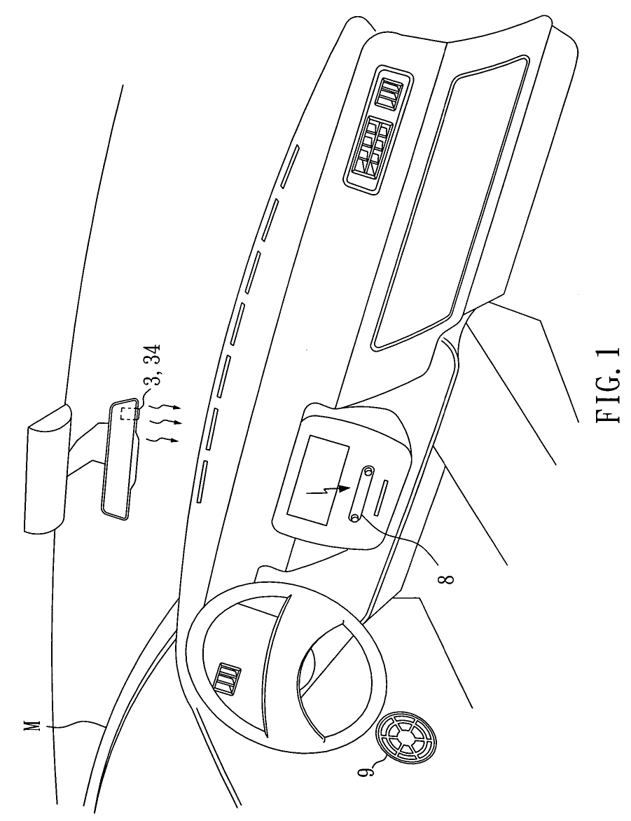

FIG. 1 is a schematic drawing showing a status of use of the preferred embodiment of the present invention inside a car M. The car M has installed therein a FM radio 8, a speaker 9, and a rearview mirror. The FM radio 8 is mounted in the passenger room inside the car M. The speaker 9 is mounted in the doorframe of the door adjacent to the driver's seat. The rearview mirror is provided at the bottom side of the roof of the car M. The rearview mirror has a music player module, which will be described in detail below.

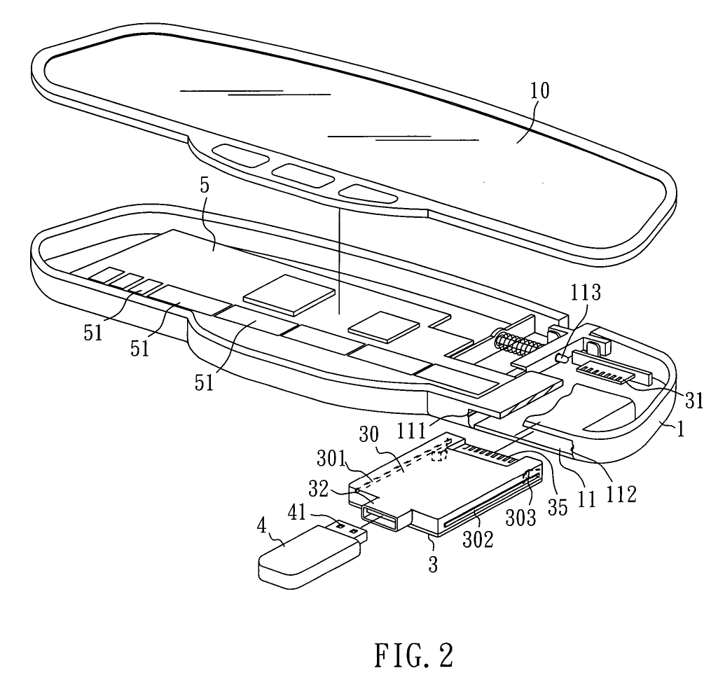

Referring to FIG. 2, the rearview mirror of the present invention comprises a casing 1, a mirror 10 covering the casing 1, and a control circuit board 5 mounted inside the casing 1. The control circuit board 5 controls a plurality of LED displays 51 to produce a visual signal through the translucent mirror 10, having a second connecter3l extending out of one side thereof. The casing 1 has an accommodating chamber 11 at one lateral side, two sliding grooves 111 and 112 arranged in parallel at two opposite lateral sides of the accommodating chamber 11, and a male retaining element, for example, spring latch 113 set in the deep inside of the accommodating compartment 11.

The music player module, referenced by 3, has a housing 30 fitting the accommodating chamber 11 of the casing 1. The housing 30 has two sliding rails 301 and 302 symmetrically disposed at two opposite lateral sides corresponding to the sliding grooves 111 and 112 in the accommodating chamber 11, and a female retaining element, for example, a retaining hole 303 transversely disposed near the front side. When inserting the music player module 3 into the accommodating chamber 11, of the casing 1, the sliding rails 301 and 302 of the housing 30 of the music player module 3 are respectively coupled to the sliding grooves 111 and 112 in the accommodating chamber 11. After the music player module 3 has been set into position, the spring latch 113 automatically engages the retaining hole 303, thereby locking the music player 3 to the casing 1. On the contrary, when pulled the spring latch 113 away from the retaining hole 303, the music player module 3 is unlocked and can be removed from the casing 1.

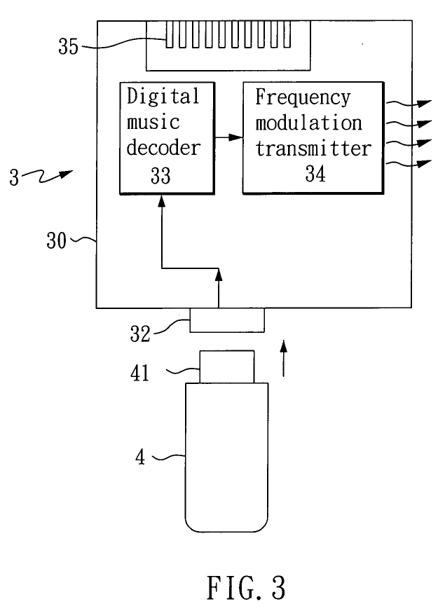

Referring to FIG. 3 and FIG. 2 again, the music player module 3 comprises an input connecter 32, a music decoder 33, and a FM transmitter 34. The music decoder 33 is electrically connected to the input connecter 32 and the FM transmitter 34. According to this embodiment, the music decoder 33 is a MP3 player, and the input connecter 32 is a USB connection connecter. Alternatively, the input connecter 32 can be a IEEE-1394 connecter or any of a variety of other equivalent connection terminals.

Referring to FIGS. 2 and 3 again, the data storage device, referenced by 4, is a plug type Mass Storage Class (flash memory), having stored therein multiple pieces of music files of MP3 format. Further, the data storage device 4 has a USB first connecter 41 connectable to the input connecter 32 of the music player module 3.

After connection of the data storage device 4 to the second connecter 32 of the music player module 3, the MP3 player (music decoder 33) fetches and decodes MP3 music files from the data storage device 4, and then sends the decoded MP3 music files to the outside air wirelessly at a predetermined frequency modulation band through the FM transmitter 34.

Referring to FIG. 1 again, due to limited space of the passenger room inside the car M and short distance between the music player module 3 and the FM radio 8, the strong FM radio wave transmitted from the FM transmitter 34 overlays other FM radio waves from external FM radio stations, there by the RF radio 8 receives decoded MP3 digital music transmitted from the FM transmitter 34 and outputs the received MP3 digital music through the speaker 9.

As indicated above, the invention has the music decoder 33 (MP3 player) incorporated into a rearview mirror inside a car. This arrangement fully utilizes the limited inside space of the car, keeping the sense of beauty of the inside space of the car intact. Further, the data storage device 4 (a portable data storage device of Mass Storage Class,) can be disconnected from the music player module 3 and moved out of the car to a suitable place to download MP3 music files for further output through the music player module 3.

Referring to FIG. 2 again, the music player module 3 has a first connecter35 (the so-called gold finger) connectable to the second connecter3l of the control circuit board 5. The first connecter35 of the music player module 3 and the second connecter 31 of the control circuit board 5 can be RS-232 connection terminals or any of a variety of other suitable types of connection terminals. The music player module 3 can be set to obtain the necessary working voltage from the car battery power supply. Alternatively, the battery pack (not shown) can be installed in the rearview mirror to provide the music player module 3 with the necessary working voltage.

Further, the control circuit board 5 can be constructed to have a band selection chip for carrier frequency range selection from the full frequency range, and the selected new frequency range is sent to the FM transmitter 34 to replace the predetermined frequency band, enabling the FM transmitter 34 to broadcast at the new frequency band. Therefore, the invention can select to transmit full frequency range frequency modulation carrier signal.

Although the present invention has been explained in relation to its preferred embodiment, it is to be understood that many other possible modifications and variations can be made without departing from the spirit and scope of the invention as hereinafter claimed.

What is claimed is:

1. A rearview mirror comprising:
a casing, said casing having an accommodating chamber;
a data storage device, said data storage device having stored therein at least one digital music file; and
a music player module received in the accommodating chamber of said casing, said music player module comprising a digital music decoder electrically connectable to said data storage device for fetching said at least one digital music file from said data storage device and decoding said at least one digital music file, and a Frequency Modulation (FM) transmitter electrically connected to said digital music decoder and adapted to wirelessly send out the at least one digital music file decoded by said digital music decoder.

2. The rearview mirror as claimed in claim 1, wherein said casing comprises two sliding grooves arranged in parallel at two sides of said accommodating chamber; said music player module comprises a housing insertable into said accommodating chamber, said housing having two sliding rails disposed at two opposite lateral sides thereof corresponding to said two sliding grooves of said casing.

3. The rearview mirror as claimed in claim 1, wherein said casing further comprises a retaining element disposed inside said accommodating chamber; said music player module comprises a housing insertable into said accommodating chamber, said housing further having a retaining unit correspondingly connectable to the retaining element of said casing.

4. The rearview mirror as claimed in claim 1, wherein said at least one digital music file comprises a MP3 music file.

5. The rearview mirror as claimed in claim 1, wherein said music player module further comprises an input connecter; said data storage device is a portable data storage device of Mass Storage Class, having an output connecter connectable to the input connecter of said music player module.

6. The rearview mirror as claimed in claim 5, wherein the input connecter of said music player module and the output connecter of said data storage device are Universal Series Bus (USB) connection connecters.

7. The rearview mirror as claimed in claim 1, further comprising a control circuit board mounted inside said casing, said control circuit board comprising a second connecter electrically connected to a first connecter of said music player module.

8. The rearview mirror as claimed in claim 1, wherein said Frequency Modulation (FM) transmitter is capable to transmitting full frequency range of Frequency Modulation (FM) carrier signal.

9. The rearview mirror as claimed in claim 1, which is installed in a motor vehicle having a Frequency Modulation (FM) radio for receiving the decoded digital music file transmitted by said Frequency Modulation (FM) transmitter, and at least one speaker; said Frequency Modulation (FM) radio electrically connected to said at least one speaker for controlling said at least one speaker to output the received decoded digital music file.
